(19) United States
(12) Patent Application Publication
(10) Pub. No.: US 2008/0097214 A1
(43) Pub. Date: Apr. 24, 2008

(54) Ophthalmic ultrasound probe assembly

(75) Inventors: Paul F. Meyers, San Juan Capistrano, CA (US); Jose Cevellos, Mission Viejo, CA (US)

Correspondence Address: STETINA BRUNDA GARRED & BRUCKER, 75 ENTERPRISE, SUITE 250, ALISO VIEJO, CA, 92656, US

(73) Assignee: Capistrano Labs, Inc.

(21) Appl. No.: 11/515,602

(22) Filed: Sep. 5, 2006

(51) Int. Cl. G01N 29/00

(52) U.S. Cl. 600/459

(57) ABSTRACT

An ultrasonic probe assembly comprises a housing defining a longitudinal axis and having a linear motor assembly, a swivel base, and an extension arm disposed therewithin. An imaging transducer is mounted on a free end of the extension arm and is specifically adapted to be moved along an arcuate path as a result of mechanical interconnection of the swivel base to the linear motor assembly. The swivel base upon which the extension arm is mounted is configured to be pivotable about a pivot axis oriented transversely relative to the longitudinal axis such that reciprocative motion of the linear motor assembly is converted in swiveling motion of the swivel base and oscillating translation of the transducer along an arcuate path such that the transducer axis is oriented generally perpendicularly relative to an anatomical structure having a convexly shaped outer surface.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND

The present invention relates generally to ultrasonic probes and, more particularly, to a uniquely configured ultrasonic probe assembly specifically adapted for diagnostic imaging of convexly shaped anatomical structures.

In the field of ultrasonic diagnostics, acoustic images of anatomical structures are utilized in the diagnosis of various medical disorders and conditions. In producing such images, beams of acoustic or ultrasonic energy are transmitted from a transducer such as a piezoelectric transducer into the body tissue of a patient. Reflected acoustic energy or echoes received by the ultrasonic probe are processed into an image format that is suitable for display. In ophthalmological diagnostic ultrasonography, ultrasound pulses are directed from a transducer into a patient's eye for imaging the anterior and posterior segments, as well as eye surfaces.

In preparation of certain surgical procedures, imaging of such structures, especially those of the anterior segment, must be performed with a high degree of accuracy. For example, in one surgical procedure for correcting refractive errors (e.g., near-sightedness, far-sightedness and astigmatic eyes) in a human eye, a small corrective implantable contact lens or phakic intraocular lens (PIOL) is surgically implanted behind the iris in front of the natural lens. Highly accurate imaging or mapping of the eye is required in order to provide accurate measurements of the geometry of tissues of the eye.

In the case of PIOL surgery, ultrasonic imaging is employed to measure the sulcus-to-sulcus distance across the eye so that an appropriately-sized PIOL may be fabricated which matches the unique geometry of the eye. The fitting of the PIOL is a critical part of the surgical procedure as inserting a PIOL of incorrect size may result in rotational movement of the PIOL inside the eye which could cause damage to the natural lens upon which the PIOL rests. Other serious complications could arise as a result of an incorrectly-sized PIOL. For example, an incorrectly-fitted PIOL may result in blocking of the natural flow of fluid inside the eye which could eventually result in glaucoma.

For highest accuracy of ultrasonic scanning, the ultrasonic beam is ideally reflected against a surface at an angle that is normal or perpendicular thereto such that the echoes are reflected directly back to the transducer. If the ultrasonic beam of the probe strikes the scanned surface at an oblique angle, the accuracy of the ultrasonic scanning is reduced as a result of both reflection of the echoes away from the transducer and refraction of the echoes. The former results in reduction in echo strength and the latter results in slight geometric distortion. Reflected echoes may go completely undetected as they are reflected away from the transducer and are therefore not captured. As such, it is highly desirable that the ultrasonic beam is oriented substantially perpendicularly relative to the surface such that oblique reflections are minimized.

Due to the curved outer surface of the eye, conventional “sectoring” or sector scanning ultrasonic probes are typically not suitable for ophthalmological purposes as such ultrasonic probes cannot maintain normality of the ultrasonic beam with the surface of the eye. If such conventional probes were used, image quality can be drastically reduced due to the reflection of ultrasonic beams at an oblique angle. As such, it is necessary to provide an ultrasonic probe that is capable of producing generally arcuate movement of the ultrasonic beam along a path that is generally matched to the curvature of the cornea. Ideally, the arcuate path along which the ultrasonic beam is directed approximates the curvature of the eye such that the ultrasonic beam remains substantially perpendicular to the surface of the cornea during the scan.

As can be seen, there exists a need in the art for an ultrasonic probe assembly that has the capability to accurately image curved surfaces such as the surface of a cornea in order to minimize oblique reflections. More specifically, there exists a need in the art for an ultrasonic probe assembly that is specifically adapted to move along an arcuate translation path which closely approximates the curvature of the cornea such that the transducer is maintained in a constant perpendicular relationship to the surface of the eye. Furthermore, there exists a need in the art for an ultrasonic probe assembly which provides the above-recited scanning characteristics in a device that is of relatively low cost and simple construction.

### BRIEF SUMMARY

The present invention specifically addresses and alleviates the above mentioned deficiencies associated with the prior art. More particularly, the present invention comprises an ultrasonic probe assembly that is uniquely adapted to provide accurate imaging of curved portions of the human anatomy such as the surface of the cornea by mechanically moving an ultrasonic transducer along an arcuate path that closely approximates the shape of the human eye. In this regard, the ultrasonic probe assembly of the present invention transmits an ultrasonic beam that is generally oriented substantially perpendicular to the surface of the cornea which minimizes oblique reflections of the ultrasonic beams so as to maximize reflected signal energy and accuracy.

Although the present invention is especially well-suited for the ultrasonic imagery of convexly shaped anatomical structure such as the human cornea, it will be appreciated that the ultrasonic probe assembly may be suited for imaging of various other anatomical structures having different radii of curvature. Toward this end, the ultrasonic probe assembly may be fitted with a removable track assembly such that track assemblies of different curvature may be interchangeably mounted to the ultrasonic probe assembly depending upon the particular anatomical structures to be imaged.

The ultrasonic probe assembly comprises a housing having opposing ends and defining a longitudinal axis. An imaging transducer may be mounted to the housing adjacent to one of the ends. The transducer defines a transducer axis that is specifically configured to be moved along an arcuate path in a manner such that the transducer axis is generally maintained in substantially perpendicular relationship to the anatomical structure regardless of the position of the transducer along the arcuate path. It is contemplated that the scanning ultrasonic transducer may be moved along an arc of approximately 50 degrees having a radius of approximately 40 mm although the probe assembly may be configured such that the transducer may be moved along any angular sweep and at a variety of different radii.

The probe assembly additionally comprises a linear motor assembly mounted within the housing and which is operative to reciprocate along the longitudinal axis. A swivel base is disposed within the housing and is mechanically connected to the linear motor assembly. The swivel base is specifically configured to be pivotable about a pivot axis oriented generally transversely relative to the longitudinal axis. In this manner, reciprocative motion of the linear motor assembly may be converted into swiveling motion of the swivel base. An extension arm extending outwardly from the swivel base has the transducer mounted on a free end thereof. The extension arm and, hence, the transducer may be moved in oscillating motion along the arcuate path in response to the pivotal motion of the swivel base.

The probe assembly may further comprise a carriage which is adapted to be movable along the arcuate path. The carriage is slideably connected to the free end of the extension arm such that as the extension arm pivots back-and-forth, the transducer is moved back-and-forth between extreme ends of the arcuate path. As was earlier mentioned, the housing may include a pair of arcuate tracks formed or mounted therein. The carriage may include a carriage body having two pairs of rollers mounted on opposing sides of the carriage body. The rollers are sized and configured to move within the arcuate tracks thereby carrying the transducer in an arc.

The housing may be comprised of a handle portion that is preferably ergonomically sized and shaped for convenient grasping by a human hand. The housing may further include a detachable head portion having the arcuate tracks disposed therewithin. Optionally, a track assembly may be mounted in the head portion and may be configured to be separately attachable to the head portion. The track assembly may have a spaced pair of the arcuate tracks formed therewithin. In this manner, different track assemblies having arcuate tracks of varying radii of curvature may be selectively mounted to the head portion to accommodate the imaging of variously curved anatomical structures.

The linear motor assembly itself may comprise a hollow motor sleeve having a drive coil assembly coaxially mounted therewithin. The drive coil assembly may be formed as a hollow tube having at least one positive drive coil and at least one negative drive coil disposed in axial spaced relation to the positive drive coil. Coaxially disposed within the drive coil assembly is an actuator assembly comprised of a magnet assembly. The magnet assembly may be comprised of a plurality of axially-spaced and disc-shaped magnets each having opposing poles such that the magnets are oriented with the poles being disposed in opposing relation to poles of adjacent magnets. The actuator assembly is slideably supported by a pair of end guides disposed on opposing ends of the magnet assembly. The end guides are configured to axially support the actuator assembly within the drive coil assembly in order to allow the actuator assembly to reciprocate relative thereto.

Reciprocative motion produced by the linear motor assembly is imparted to the swivel base by means of a connecting rod interconnecting the linear motor assembly to the swivel base. Reciprocation of the linear motor assembly causes the swivel base and, hence, the extension arm to pivot back-and-forth. Because the transducer is mounted on a free end of the extension arm, pivoting of the swivel base causes the transducer to oscillate back-and-forth.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is a perspective view of the ultrasonic probe assembly illustrating the housing comprised of a handle portion having a head portion with a transducer translationally mounted therewithin;

FIG. 2 is a perspective view of the probe assembly shown in FIG. 1 and illustrating a sidewall of the head portion in a partially exploded state in order to illustrate a carriage slideably moveable along an arcuate track formed within the head portion;

FIG. 3 is a cross-sectional view of the ultrasonic probe assembly taken along lines 3-3 of FIG. 1 and illustrating a linear motor assembly disposed within the housing and being mechanically connected to a swivel base having an extension arm mounted thereto;

FIG. 4 is a cross-sectional view of the probe assembly taken along lines 4-4 of FIG. 1 and illustrating the extension arm slideably connected to the carriage which is configured to move along the arcuate track formed in the head portion;

FIG. 5 is a partially exploded view of the probe assembly illustrating an inner housing having the linear motor assembly contained therewithin and further illustrating a pair of prongs extending outwardly from the carriage for engaging a follower disposed on a free end of the extension arm;

FIG. 6 is an end view of the head portion illustrating the pair of rollers on opposing sides of the carriage and which are specifically adapted to move along opposing arcuate tracks formed in the sidewalls;

FIG. 7 is an exploded view of the inner housing illustrating the linear motor assembly having a gimbal cup fixedly mounted thereon with a swivel base being swivelably mounted thereto;

FIG. 8 is an exploded view of the linear motor assembly illustrating a hollow motor sleeve having the drive coil assembly coaxially mounted therein and which itself has an actuator assembly reciprocatively mounted within the drive coil assembly;

FIG. 9 is an exploded perspective view of the actuator assembly illustrating an inner sleeve within which a magnet assembly is coaxially mounted;

FIG. 10 is a perspective view of the linear motor assembly illustrating the interconnective relationship of the gimbal cup to the swivel base;

FIG. 11 is an exploded perspective view of the linear motor assembly having an end fitting for mounting the gimbal cup to the linear motor assembly;

FIG. 12 is a perspective exploded view of the gimbal cup and illustrating the interconnective relationship between a clevis fitting of the linear motor assembly via a connecting rod pivotally attached to the swivel base;

FIG. 13 is a perspective exploded view of the gimbal cup and swivel base in an alternative embodiment wherein the extension arm is replaced by a telescopic mechanism interconnecting the swivel base to the carriage;

FIG. 14 is a partially exploded view of the probe assembly having a telescopic mechanism in an alternative embodiment of the extension arm;

FIG. 15 is an enlarged partial cross-sectional view of the head portion of the probe assembly illustrating the relative positioning of the extension arm and the carriage during movement of the transducer along the arcuate tracks;

FIG. 16 is a partial exploded perspective view of the head portion illustrating an interchangeable track assembly configured to be mounted to the head portion for supporting the carriage during its slideable movement along the arcuate tracks;

FIG. 17 is an exploded view of the carriage assembly and extension arm illustrating the pair of prongs which are specifically adapted to engage an annular groove formed in a follower mounted on a free end of the extension arm; and

FIG. 18 is an exploded perspective view of the carriage assembly illustrating two pairs of rollers mounted on opposing sides of the carriage body and wherein the transducer and transducer connector are mounted on opposing upper and lower sides of the carriage body.

### DETAILED DESCRIPTION

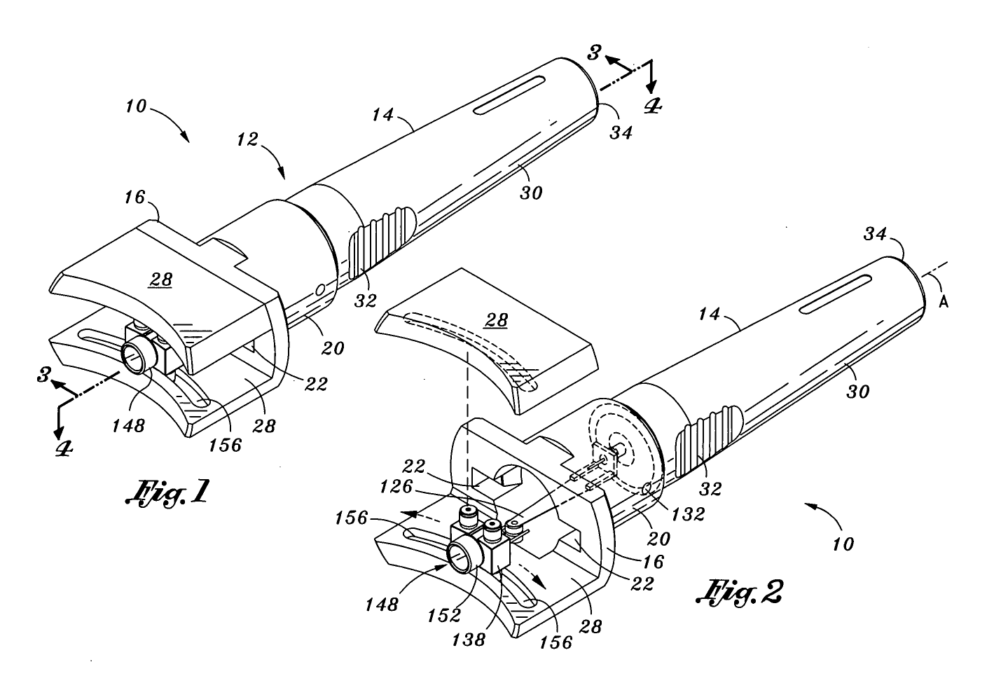

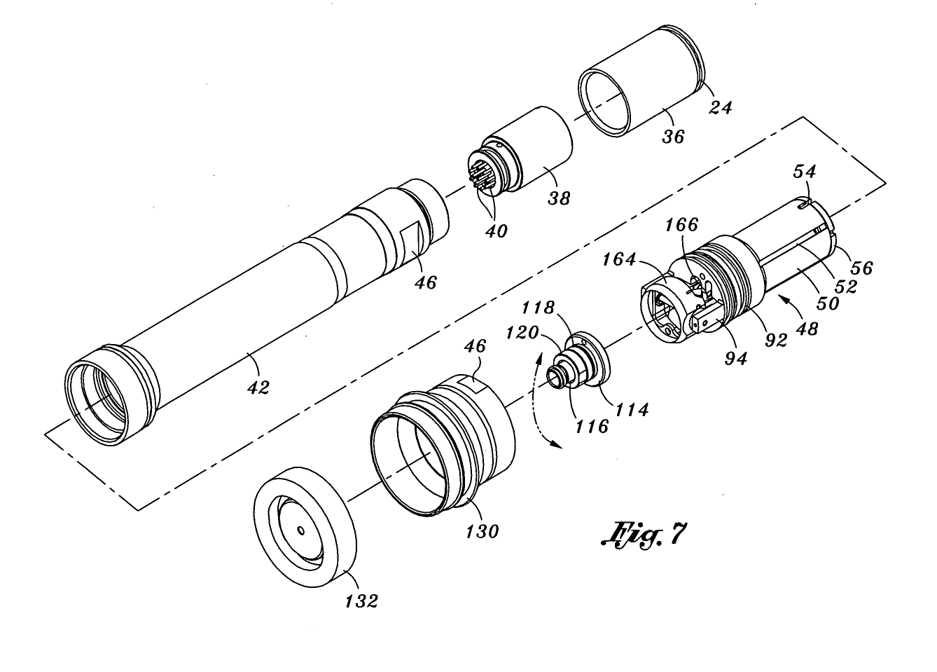

Referring now to the drawings wherein the showings are for purposes of illustrating preferred embodiments of the present invention only and not for purposes of limiting the same, FIGS. 1-18 illustrate an ultrasonic probe assembly 10 that is uniquely configured for ultrasonic imaging of convexly shaped anatomical structures such as the surface of the cornea. As will become apparent in the following description, the ultrasonic probe assembly 10 is specifically adapted to transmit an ultrasonic beam by a transducer 148 moving along an arcuate path in such a manner that the ultrasonic beam is oriented generally perpendicularly relative to the anatomical structure that is being imaged.

The ultrasonic probe assembly 10 incorporates a linear motor assembly 48 which reciprocates along a longitudinal axis A of the ultrasonic probe assembly 10. A connecting rod 100 connects the linear motor assembly 48 to a swivel base 114 having an extension arm 126 extending outwardly therefrom. The transducer 148 is mounted on a free end of the extension arm 126 such that reciprocative motion of the linear motor assembly 48 is translated into pivoting motion of the swivel base 114 which, in turn, is translated into angular oscillating motion of the transducer 148 along the arcuate tracks 156. The arcuate path is preferably configured such that the ultrasonic beam emitted by the transducer 148 is oriented substantially perpendicular relative to the anatomical structure which it is imaging.

Referring initially to FIGS. 1-6, illustrated is the ultrasonic probe assembly 10 having a housing 12 with opposing ends and which defines the longitudinal axis A. The housing 12 may be divided into a handle portion 14 and a head portion 16. The head portion 16 includes a neck portion 20 which is adapted to snugly fit over an end of the handle portion 14 such as by means of a mechanical snap fit engagement. The handle portion 14 comprises an outer housing 30 which may include a pair of opposing thumb grip 32 portions formed or molded thereinto for facilitating gripping or grasping by a user such as an ophthalmologist during operative use of the ultrasonic probe assembly 10. Within the outer housing 30 is an inner housing 42 containing the linear motor assembly 48 and a swivel mechanism which imparts oscillating motion to the transducer 148.

The housing 12 may be fabricated from a metallic material such as aluminum or it may be molded such as by injection molding of a polymeric material such as Delrin, polysulfone, or a similar suitable material. The handle portion 14 of the housing 12 may assume a generally slightly conical or tapered shape although various other shapes and sizes of the handle portion 14 are contemplated. At an end of the handle portion 14 opposite the head portion 16 is an aperture 34 through which cabled connection may be made via a cable (not shown) to connect the ultrasonic probe assembly 10 to a power supply, signal generator, and/or signal processor which may be employed in use with the probe for ultrasonic imaging.

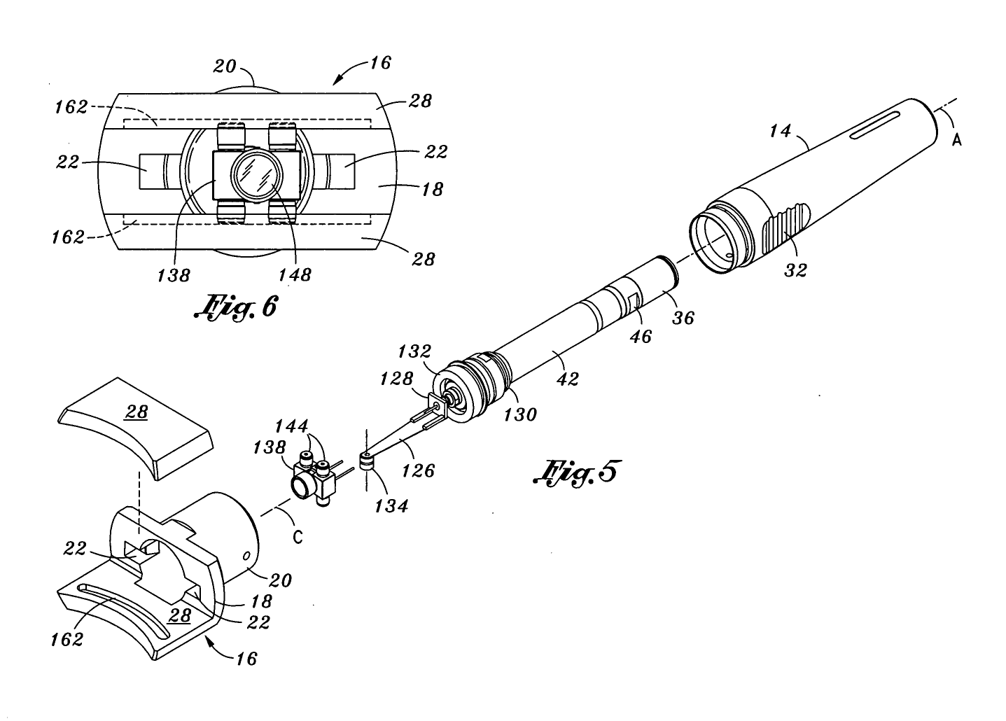

As can be seen in FIGS. 3-4, a seal 132 may be provided over the swivel base 114 in order to contain fluid between the seal 132 and the end of the handle portion 14. The seal 132 may be configured to extend about an outer circumference of a transducer cup 164 with a center portion of the seal 132 being captured between a first and second ring element 118, 120. The center portion of the seal 132 is configured to flex during pivoting movement of the swivel base 114 in a manner described in greater detail below.

Referring to FIGS. 5 and 7, shown is the inner housing 42 in partially exploded views illustrating an end cap 36 and a probe connector 38 which are joined to the inner housing 42. The end cap 36 is preferably sized and configured to be complementary to an inner diameter of the outer housing 30 in order to facilitate engagement therebetween. The end cap 36 may include an annular groove 26 for receiving an O-ring 24 for sealing engagement with the outer housing 30. The probe connector 38 is configured to fit coaxially within the end cap 36 as shown in FIGS. 3 and 4. Electrical connections of the ultrasonic probe assembly 10 are facilitated in part by electrical pins 40 protruding outwardly therefrom. The probe connector 38 is fluid-tight and its electrical pins 40 are potted therewithin. The electrical pins 40 are of the male type and they connect to a cable (not shown) which is preferably configured to provide power and signal drive as well as receive sensor output from the transducer 148. The end cap 36 may be threadably engaged to the inner housing 42. Securement of the end cap 36 may be aided by fitting a wrench to a pair of diametrically opposed flats 46 on the inner housing 42.

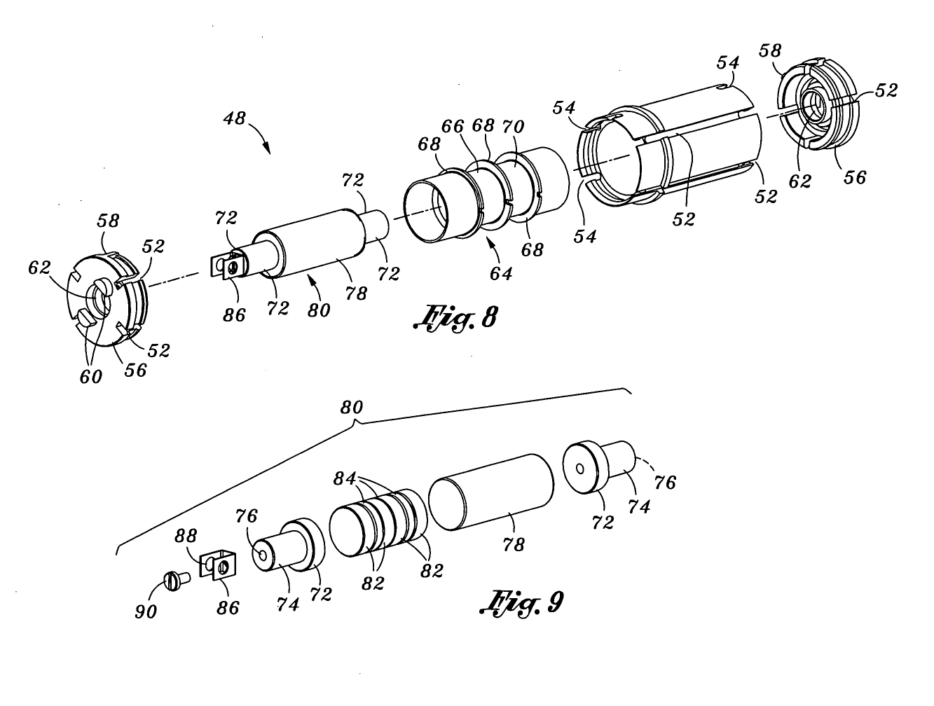

Referring to FIGS. 8-11, shown is the linear motor assembly 48 which is mounted within the inner housing 42 and which is operative to reciprocate along the longitudinal axis A of the ultrasonic probe assembly 10. The linear motor assembly 48 is comprised of a hollow cylindrical motor sleeve 50, a hollow cylindrical drive coil assembly 64 coaxially mounted within the motor sleeve 50, and an actuator assembly 80 coaxially disposed within the drive coil assembly 64. As can be seen in FIGS. 7-9, the motor sleeve 50 has a pair of opposing ends which are adapted to receive a pair of end plugs 56. The end plugs 56 may be press-fit into the opposing ends in general alignment with the various mating features on the motor sleeve 50.

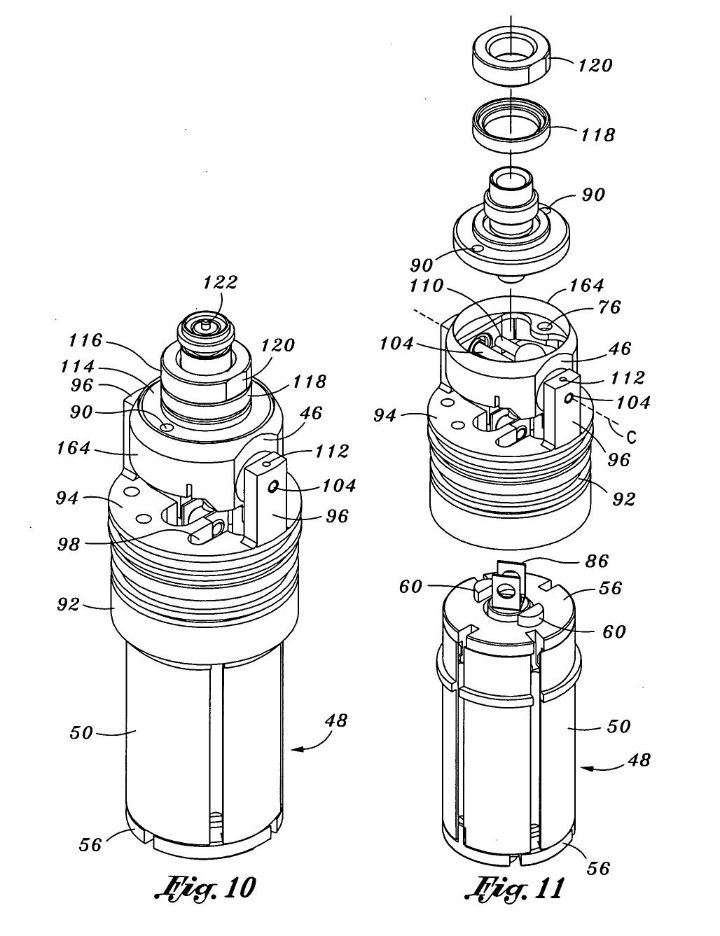

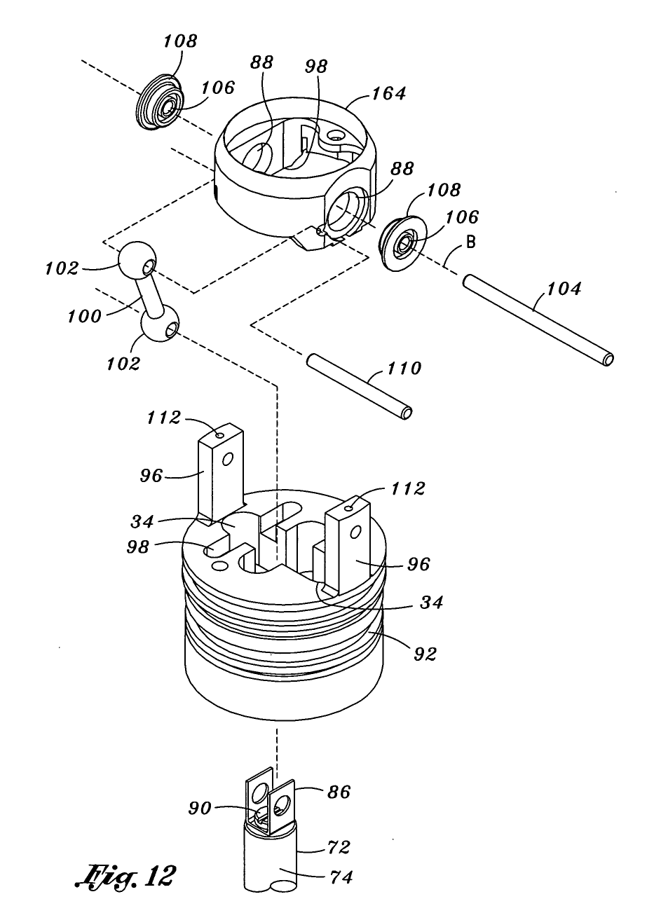

The motor sleeve 50 can be seen having at least one guide slot 54 formed in each of the opposing ends. Each of the end plugs 56 comprises at least one guide ridge 58 sized and configured to mate with the guide slot 54 of the motor sleeve 50 in order to provide alignment therebetween. Electrical connections between the transducer 148 and the electrical pins 40 of the connector 122 at the opposite end of the ultrasonic probe assembly 10 are facilitated by providing axial grooves 136 extending along the motor sleeve 50 and which are preferably aligned with axial channels 52 formed in each of the end plugs 56 as shown in FIGS. 10 and 11.

Referring still to FIGS. 8-11, mounted within the motor sleeve 50 is the drive coil assembly 64 which may be provided in a generally cylindrical and hollow configuration as shown. The drive coil assembly 64 includes at least one positive drive coil 66 and at least one negative drive coil 70 disposed in axially spaced relation to the positive drive coil 66. The drive coil assembly 64 preferably includes a set of circumferential or radial ridges 68 formed on an outer surface of the drive coil assembly 64 which serve to separate the positive and negative drive coils 66, 70 from one another. Coaxially mounted within the actuator assembly 80 and movable relative thereto is the actuator assembly 80.

As can be seen in the figures, a hollow inner sleeve 78 may be provided in order to separate the drive coil assembly 64 from the moving actuator assembly 80. In this regard, the inner sleeve 78 is preferably of a low friction material such as an insulating plastic which exhibits low frictional resistance to sliding or reciprocating movement of the actuator assembly 80 within the drive coil assembly 64. The actuator assembly 80 further comprises a magnet assembly which is coaxially disposed within the inner sleeve 78 and which itself includes a plurality of axially spaced cylindrical magnets 82 each having opposing poles which are oriented in opposing relationship to the poles of adjacent ones of the magnets 82. Spacers 84 may be included between the sets of magnets 82 as shown in FIG. 9.

In this regard, the North or “N” and South or “S” poles of the magnets 82 are disposed in opposing orientation as illustrated. When the drive coil assembly 64 is electrically energized, a magnetic field is produced. The direction of magnetic flux within the magnetic field is dependent upon current flow through the drive coil assembly 64. The flux coupling occurring between the magnet assembly and the drive coil assembly 64 during electrical energization of the drive coil assembly 64 causes movement of the actuator assembly 80 relative to the drive coil assembly 64. The direction of movement of the actuator assembly 80 is dependent on the direction of current flow within the drive coil assembly 64.

Referring still to FIG. 9, the actuator assembly 80 further includes a pair of end guides 72 disposed on respective opposing ends of the inner sleeve 78. The end guides 72 are sized and configured to fit within the inner sleeve 78 and include bushing portions 74 of reduced diameter that are configured to axially extend through bores 62 formed in the end plugs 56 of the motor sleeve 50. The end guides 72 are preferably fabricated of material providing relatively low frictional resistance to sliding motion within the bores 62 of the end plugs 56. In addition, the end guides 72 are preferably of low mass in order to minimize inertial resistance to reciprocative motion of the actuator assembly 80.

A clevis 86 may be mechanically fastened to one of the end guides 72 as shown in FIGS. 8 and 9. The clevis 86 may be mounted to the end guide 72 by means of a mechanical fastener 90 engaging a threaded hole 76 formed in the end guide 72. The clevis 86 extends through the bore 62 of the end plug 56. The linear motor assembly 48 is mounted to a gimbal cup 92 as shown in FIGS. 10 and 11. Angular alignment between the linear motor assembly 48 and the gimbal cup 92 is facilitated through the use of a pair of diametrically opposed bosses 60 each having a semi-circular cross-sectional shape. The bosses 60 are configured to engage mating apertures formed in the base 94 of a gimbal cup 92 as best seen in FIG. 12.

Extending upwardly from the base 94 of the gimbal cup 92 are a pair of diametrically opposed arms 96 upon which the transducer cup 164 is rotatably mounted. More specifically, an axle pin 104 is supported by a pair of aligned holes 88 formed in respective ones of the arms 96 which extend upwardly from the base 94 of the gimbal cup 92. A pair of orthogonally oriented set screws 112 secure the axle pin 104 within the arm 96 to prevent relative movement therebetween. The transducer cup 164 is rotatably mounted on a pair of bearings 106 disposed within bearing fittings 108 which, in turn, are engaged or fitted within holes 88 formed in the transducer cup 164. The holes 88 for the bearing fittings 108 are located adjacent to a pair of flats 46 diametrically formed on the transducer cup 164 as best seen in FIG. 12. The bearings 106 allow the transducer cup 164 to freely pivot on the axle pin 104.

Referring still to FIGS. 10-12, the swivel base 114 is fixedly mounted to the transducer cup 164 by means of mechanical fasteners 90 extending through the pair of diametrically opposing apertures formed through the swivel base 114. The mechanical fasteners 90 are configured to engage mating threaded holes 76 formed in the transducer cup 164 as can be seen in FIG. 12. Extending upwardly from the swivel base 114 is a swivel post 116 upon which may be mounted a first and second ring element 118, 120. The center portion of the seal 132 is captured between the first and second ring elements 118, 120. As will be described in greater detail below, the swivel post 116 is adapted to have the extension arm 126 mounted thereon. As was mentioned above, the free end of the extension arm 126 is adapted to provide oscillating motion to the transducer 148 along the arcuate path.

Referring briefly to FIG. 12, the connection between the clevis 86 of the linear motor assembly 48 and the transducer cup 164 is provided by a connecting rod 100 having a pair of ball ends 102 disposed on opposing (i.e., upper and lower) ends thereof. The lower one of the ball ends 102 is adapted to fit within the clevis 86 and is captured within a socket formed by the holes 88 in the clevis 86. The socket-type capturing of the lower one of the ball ends 102 prevents the transmission of torque or angular motion between the linear motor assembly 48 and the transducer cup 164. An upper one of the ball ends 102 of the connecting rod 100 is connected to the transducer cup 164 by means of a crank pin 110 oriented parallel to the axle pin 104 in offset relationship thereto.

The crank pin 110 may be fabricated of stainless steel to provide a long life and is preferably press-fit through the transducer cup 164 in parallel relationship to the axle pin 104. As was mentioned earlier, the crank pin 110 is preferably spaced apart from the axle pin 104 by a specific distance. As will be appreciated, nominal spacing is a determining factor regarding the angle through which the transducer 148 is pivoted and, hence, the translational distance along which the transducer 148 is oscillated along its arcuate path.

The gimbal cup 92 may be threadably engaged to an end fitting 130 provided with the pair of diametrically opposed flats 46 in order to facilitate tightening via a wrench. As was earlier mentioned, the seal 132 is provided over ring flange 44 of the end fitting 130 in order to contain a liquid or fluid in the areas adjacent to the swivel base 114 and gimbal cup 92. As best seen in FIGS. 3 and 4, the seal 132 extends over and covers the end fitting 130 with the extension arm 126 being mounted on the swivel base 114 on an opposite side of the seal 132. The gimbal cup 92 may be provided with an annular groove 26 for receiving an O-ring 24 for sealing engagement with the end fitting 130.

Electrical connection between the electrical pins 40 of the connector 122 at an opposite end of the handle portion 14 and the transducer 148 are provided by wires which extends upwardly along the linear motor assembly 48 and through the gimbal cup 92 and into the swivel base 114 in a manner similar to that shown and disclosed in U.S. Pat. No. 5,402,789, the entire contents of which is expressly incorporated by reference herein. However, it should be noted that the electrical connections may be provided in a wide variety of alternative configurations.

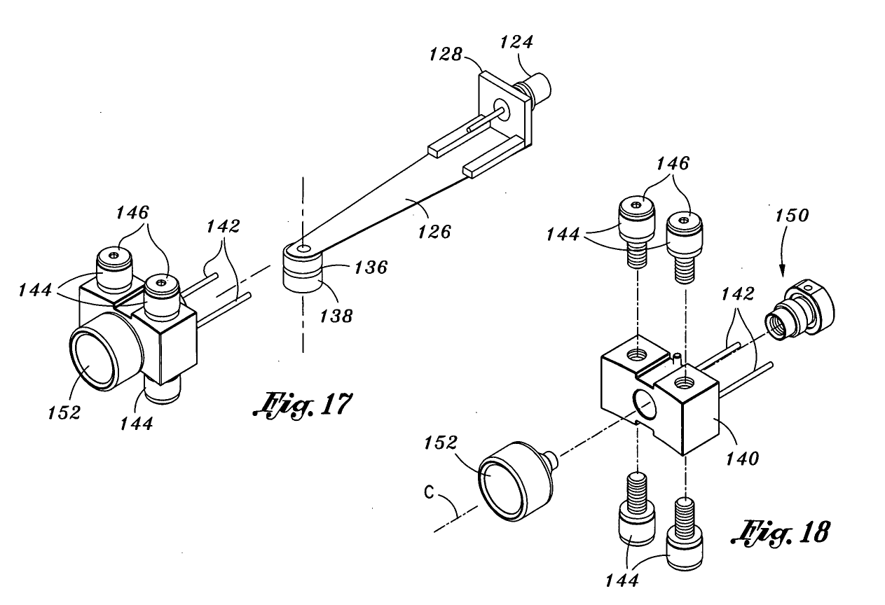

Referring now to FIGS. 3-5 and 15-17, the extension arm 126 can be seen as extending laterally outwardly from the extension base 128. The extension base 128 may include an extension mount 124 having a threadable fitting which is adapted to engage the swivel base 114 as best seen in FIG. 17. The extension base 128 may include a pair of reinforcing arms extending upwardly to which the extension arm 126 may be fastened or mounted. An electrical connection can be seen in FIG. 17 as extending upwardly through the extension base 128 in order to facilitate electrical connection to the transducer 148. A free end of the extension arm 126 has a rotatable roller or follower 134 rotatably mounted thereon. The follower 134 may include an annular groove 26 formed therearound and may be located in a generally axially-centered portion of the follower 134.

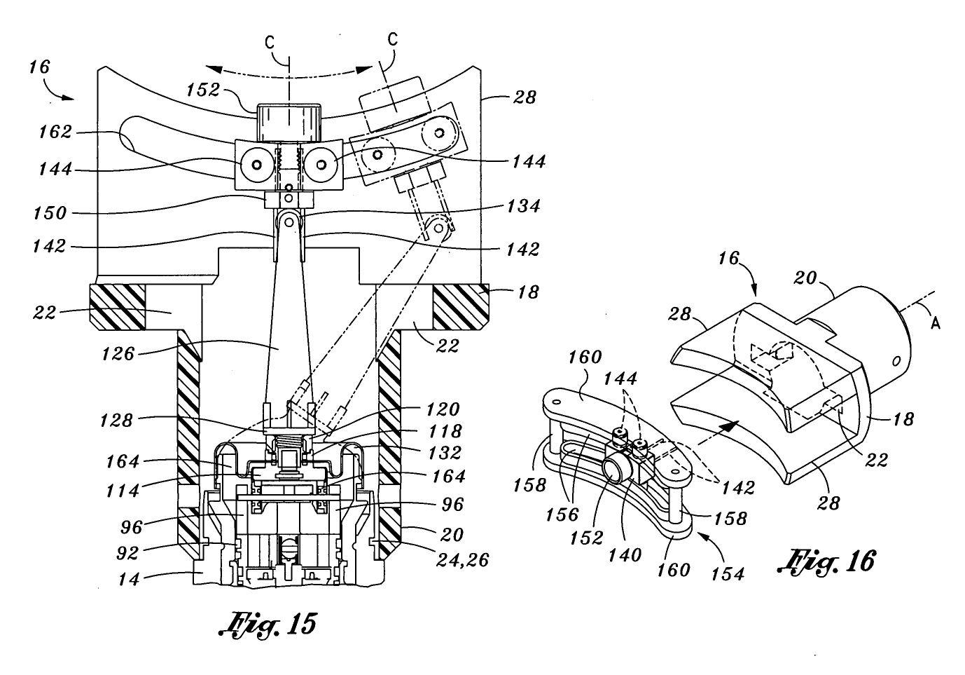

Although the extension arm 126 is shown as a generally flat plate configuration having a tapered shape, the extension arm 126 may be provided in a wide variety of alternative shapes, sizes and configurations suitable to provide substantial rigidity while facilitating electrical connection between the extension base 128 and the transducer 148. As can be seen in FIG. 15, the extension arm 126 is specifically sized and configured to be complementary to the head portion 16 of the housing 12 in order to allow for maximum angular movement of the extension arm 126 as a result of pivoting of the swivel base 114. In this regard, a pair of cutaways 22 may be provided in the head portion 16 as shown in FIG. 15 wherein a portion of material has been removed in order to prevent interference between the extension arm 126 and the base wall 18 of the head portion 16 during operation (i.e., oscillation) of the ultrasonic probe assembly 10.

The transducer 148 may preferably be mounted on a carriage 138 comprising a carriage body 140 having a set of four rollers 144 which are adapted to ride within a pair of opposing arcuate tracks 156 formed in sidewalls 28 of the head portion 16. The carriage body 140 may be fabricated of a generally rigid material such as aluminum, stainless steel or a polymeric material to which the rollers 144 may be mounted by means of roller bearings 146. The roller bearings 146 may be threadably engaged to opposing sides of the carriage body 140 as shown in FIGS. 17 and 18. The transducer 148 itself may be threadably engaged to the transducer connector 150 such that the carriage body 140 is captured therebetween.

A transducer connector 150 may extend downwardly from the carriage body 140 and may include a spaced pair of prongs 142 which are sized and configured to fit within and to engage the annular groove 26 formed in the follower 134. In this manner, the carriage 138 is slideably connected to the free end of the extension arm 126 wherein the prongs 142 move axially relative to the follower 134 while allowing relative angular motion between the carriage body 140 and the extension arm 126. In this manner, the transducer 148 is translatable along the arcuate path in response to swiveling of the swivel base 114 during activation of the linear motor assembly 48.

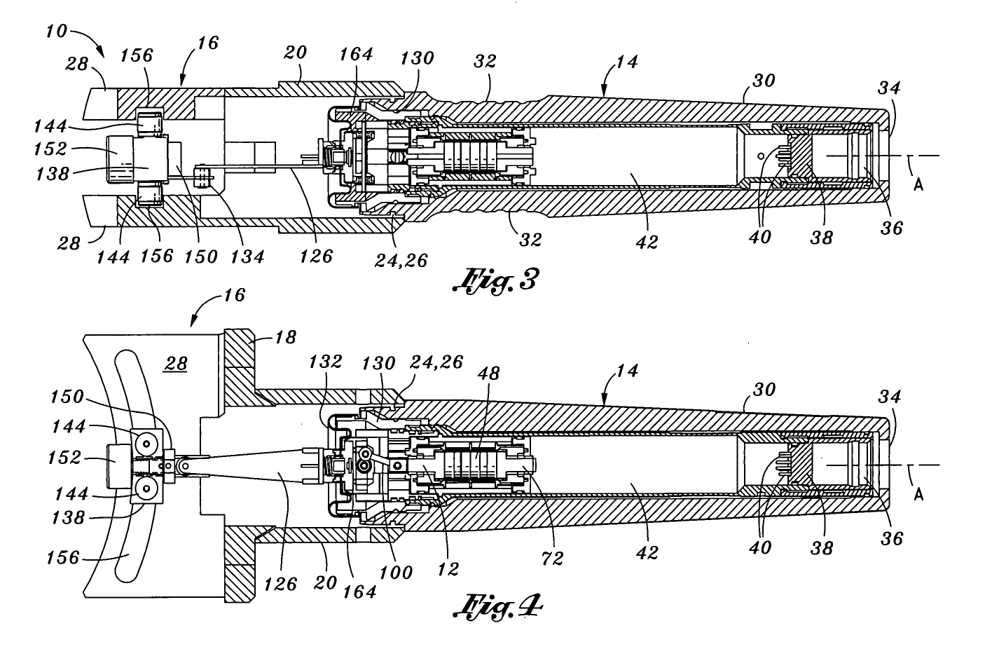

As can be seen in FIGS. 2 and 4, the arcuate path is defined by a spaced of arcuate tracks 156 disposed in the head portion 16 of the housing 12. More specifically, each of the sidewalls 28 of the head portion 16 may include one of the arcuate tracks 156 which are sized and configured to be complementary to the rollers 144 such that the carriage 138 may slide along the arcuate track 156. As was earlier mentioned, the arcuate track 156 preferably has a radius that is complementary to the anatomical structure to be imaged. For example, the radius of the arcuate path along which the transducer 148 moves via the carriage 138 may be approximately 40 mm such that the transducer 148 may be moved in a manner that allows the ultrasonic beam to strike the corneal surface at an orientation that is substantially normal or perpendicular thereto in order to avoid oblique reflections.

However, the arcuate tracks 156 may be formed at any radius of curvature that is complementary to the anatomical structure to be imaged. It is contemplated that the ultrasonic probe assembly 10 may further include a track assembly 154 wherein the arcuate tracks 156 are provided in varying radii of curvature in order to allow imaging of anatomical structure having different radii of curvature. As best seen in FIG. 16, the arcuate track 156 may be a separate component that may be configured to be removably attachable to the head portion 16 such as by fitment between the sidewalls 28. The track assembly 154 itself may be comprised of a spaced pair of arcuately-shaped track beams 160 interconnected by a spaced pair of struts 158. Each of the track beams 160 has one of the arcuate tracks 156 formed therein and along which the rollers 144 of the carriage 138 may slide.

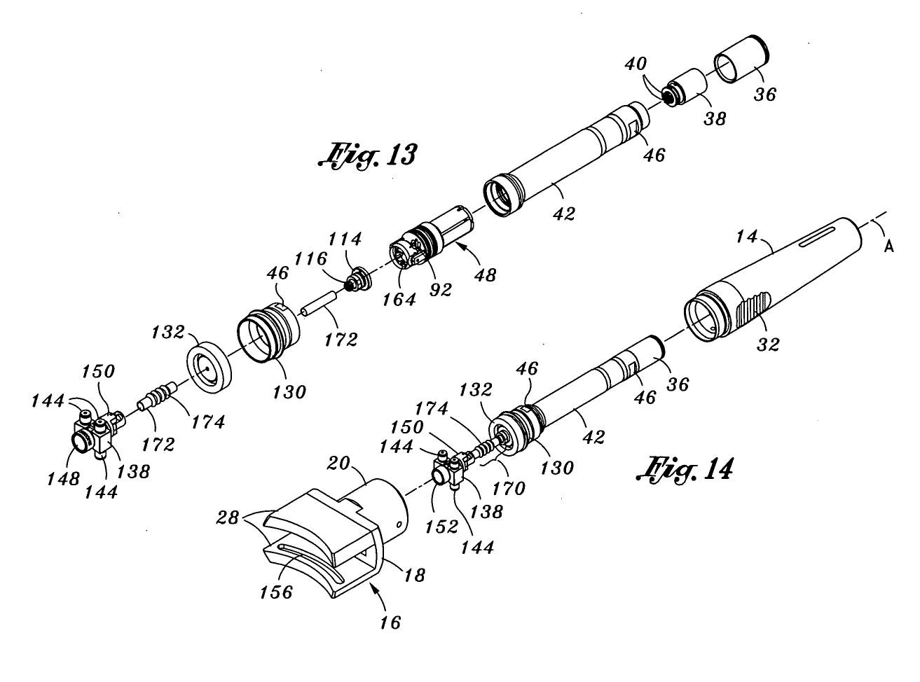

Referring briefly to FIGS. 13 and 14, shown is the probe assembly 10 wherein the extension arm 126 is provided in an alternative embodiment. As can be seen, the extension arm 126 may include a telescopic mechanism 170 provided between the swivel base 114 and the carriage 138 in order to allow for axial extension and retraction during the angular pivoting motion of the extension arm 126. The telescopic mechanism 170 may be comprised of a pair of hollow tubular post elements 172 configured to fit within one another and wherein a biasing member 174 is provided approximately midway along the telescopic mechanism 170. The biasing member 174 biases or urges the extension arm 126 back toward its neutral position from extreme ends of it angular oscillation.

As may be appreciated, the post elements 172 are axially slidable relative to one another during this oscillating motion. The mounting of the telescopic mechanism 170 to the swivel base 114 may be similar to that shown and described above for the extension base 128. The slideable attachment of the extension arm 126 to the carriage 138 is replaced by a pivoting connection between the carriage 138 and the uppermost one of the post elements 172 in order to allow the carriage 138 to rotate relative to the post element 172 during arcuate travel of the carriage along the arcuate track 156.

Referring to FIGS. 10-12, it should be noted that the ultrasonic probe assembly 10 of the present invention is preferably fitted with a pivotal position sensor 98 such that the angular position of the swivel base 114 relative to the gimbal cup 92 may be accurately determined at any time during operation of the probe assembly 10. The position sensor 98 may be integrated into the transducer cup 164 in a manner similar to that shown and described in U.S. Pat. No. 5,402,789. In this regard, the position center is preferably operative to provide a sensor output indicative of the precise instantaneous angle at which the swivel base 114 may be tilted relative to the gimbal cup 92.

Sensor output may be preferably obtained from a position-sensing toroidal coil (not shown) wherein the toroidal coil may be affixed within an aperture formed in the gimbal cup 92 and shown in FIG. 12 as a slot. A spirally shaped flange (not shown) may be affixed to the transducer cup 164 along one side thereof and which is rotatable with the transducer cup 164. Due to the spiral shape of the flange, a varying amount of cross-sectional area of the flange is passed between a gap within the toroidal coil as the flange variably enters the toroidal coil. Depending upon the amount of angular tilt of the swivel base 114 relative to the gimbal cup 92, the contour of the flange is preferably such that a variable amount of metallic material (nominally, a ferrous metal) will be rotated into and passed within the gap of the toroidal coil. The amount of metal entering the gap alters the inductance of the toroidal coil in a manner which may be sensed by interconnected electronics circuitry (not shown). Accordingly, the toroidal coil in combination with the flange may constitute a position sensor 98 for sensing the angular tilt of the swivel base 114 and, hence, of the transducer 148 along the arcuate track 156.

The operation of the ultrasonic probe assembly 10 will now be described with reference to the figures. Upon electrical energization of the linear motor assembly 48, the actuator assembly 80 is caused to reciprocate in alignment with longitudinal axis A of the probe assembly 10. The reciprocating motion of the actuator assembly 80 is effectuated by regulating the drive current passing through the drive coil assembly 64. The interconnection of the clevis 86 from the linear motor assembly 48 to the crank pin 110 of the transducer cup 164 as mechanically illustrated in FIGS. 10-12 causes the swivel base 114 to pivot about the axle pin 104 in an oscillating manner. The extension arm 126 which is fixedly secured to the swivel post 116 is then caused to angularly oscillate.

The resultant angular oscillation of the extension arm 126 causes the carriage 138 assembly to translate back-and-forth along the arcuate track 156 resulting in the transducer mounted on the carriage 138 to be moved such that the transducer axis C is maintained in perpendicular relationship to the track assembly 154. Preferably, the radius of curvature of the track assembly 154 closely approximates the anatomical structure to be imaged. The ability to maintain perpendicularity of the transducer with the anatomical structure is dependent in part upon the axial distance from the transducer head 152 to the anatomical structure surface. Such perpendicular relationship of the ultrasonic beam emitted by the transducer 148 to the anatomical structure permits the present invention to effectively image structure having convexly shaped surfaces in an accurate manner relative to that of prior art devices.

Optionally, the ultrasonic probe assembly 10 may be utilized in conjunction with an eye cup in order to maintain a desired axial distance between the transducer head 152 and the corneal surface as well as to minimize lateral movement of the probe assembly 10 during scanning which would otherwise reduce the accuracy and resolution of the imaging result. Advantageously the combination of the ultrasonic probe assembly 10 with the eye cup minimizes oblique reflections from the corneal surface and therefore maximizes reflected signal energy from the ultrasonic beam emitted by the transducer 148. In this regard, the maintenance of such perpendicularity increases the accuracy of corneal thickness and geometrical measurements that are critical in the fabrication of an appropriately-sized PIOL.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. An ultrasonic probe assembly, comprising:
a housing having opposing ends and defining a longitudinal axis;
an imaging transducer mounted to the housing adjacent to one of the opposing ends, the transducer defining a transducer axis and being configured to be moved along an arcuate path in a manner such that the transducer axis is oriented generally perpendicularly relative to an anatomical structure having a convexly shaped outer surface.

2. The probe assembly of claim 1 wherein the radius of the arcuate path along which the transducer moves is approximately 40 mm.

3. The probe assembly of claim 1 further comprising:
a linear motor assembly mounted within the housing and being operative to reciprocate along the longitudinal axis;
a swivel base mounted within the housing and being mechanically connected to the linear motor assembly and being configured to be pivotable about a pivot axis oriented transversely relative to the longitudinal axis such that reciprocative motion of the linear motion is converted into swiveling motion of the swivel base;
an elongate extension arm fixedly connected to and extending outwardly from the swivel base;
wherein:
the transducer is mounted on a free end of the extension arm in a manner such that the pivotal motion of the swivel base is converted into oscillating motion of the transducer along the arcuate path.

4. The probe assembly of claim 3 further comprising a connecting rod extending outwardly from the linear motor assembly and interconnecting the linear motor assembly to the swivel base.

5. The probe assembly of claim 3 further comprising a carriage slidably connected to the free end of the extension arm and being movable along the arcuate path, the transducer being fixedly mounted to the carriage.

6. The probe assembly of claim 5 wherein:
the arcuate path is defined by a spaced pair of arcuate tracks disposed in the housing;
the carriage having opposing sides and including a pair of rollers mounted on each of the opposing sides;
the rollers being sized and configured to move within the arcuate tracks.

7. The probe assembly of claim 6 wherein the housing comprises a handle portion and a detachable head portion having the pair of arcuate tracks disposed therein.

8. The probe assembly of claim 7 wherein:
the head portion includes a track assembly mounted thereon and having a spaced pair of arcuately shaped track beams interconnected by a pair of struts;
each of the track beams having one of the arcuate tracks formed therewithin.

9. The probe assembly of claim 7 wherein the track assembly is configured to be removably attachable to the head portion.

10. The probe assembly of claim 1 wherein the transducer is configured to be removably connectable to the carriage.

11. The probe assembly of claim 1 wherein the linear motor assembly comprises:
a hollow motor sleeve having opposing ends;
a hollow drive coil assembly coaxially mounted within the motor sleeve and including;
at least one positive drive coil;
at least one negative drive coil disposed in axially spaced relation to the positive drive coil; and
an actuator assembly coaxially disposed within the drive coil assembly and including:
a magnet assembly having opposing ends and comprising a plurality of axially spaced cylindrical magnets each having opposing poles oriented in opposing relation to poles of adjacent ones of the magnets;
a pair of end guides disposed on the opposing ends of the magnet assembly and extending axially through an adjacent one of the bores for axially slidably supporting the actuator assembly within the drive coil assembly; and
wherein:
the actuator assembly and drive coil assembly cooperate to effectuate reciprocation of the actuator assembly.

12. The probe assembly of claim 11 wherein:
the drive coil assembly is cylindrically shaped;
the actuator assembly being sized and configured to be complementary to the drive coil assembly.

13. A linear motor assembly for an ultrasonic probe assembly having an imaging transducer defining a transducer axis and being configured to move along an arcuate path in a manner such that the transducer axis is oriented generally perpendicularly relative to an anatomical structure having a convex outer surface, the linear motor assembly comprising:
a hollow cylindrical motor sleeve having opposing ends and defining a longitudinal axis;
a pair of end plugs disposed on respective ones of the motor sleeve opposing ends, each of the end plugs having a bore extending axially therethrough;
a hollow cylindrical drive coil assembly coaxially mounted within the motor sleeve and including;
a positive drive coil; and
a negative drive coil disposed in axially spaced relation to the positive drive coil; and
an actuator assembly reciprocatively coaxially disposed within the drive coil assembly and including:
a hollow inner sleeve having opposing ends;
a magnet assembly coaxially disposed within the inner sleeve and including a plurality of axially spaced cylindrical magnets each having opposing poles oriented in opposing relation to poles of adjacent ones of the magnets; and
a pair of end guides disposed on respective ones of the inner sleeve opposing ends and being sized and configured to extend axially through an adjacent one of the bores for axially slidably supporting the actuator assembly within the drive coil assembly;
wherein:
the actuator assembly and drive coil assembly cooperate to effectuate pivotal movement of the extension arm;
the transducer being slidably connected to a free end of the extension arm in a manner such that pivotal movement of the extension arm effectuates movement of the transducer along the arcuate path.

14. The linear motor assembly of claim 1 further comprising:
a swivel base mounted within the housing and being mechanically connected to the linear motor assembly and being configured to be pivotable about a pivot axis oriented transversely relative to the longitudinal axis such that reciprocative motion of the linear motion is converted into swiveling motion of the swivel base; and
an elongate extension arm fixedly connected to and extending outwardly from the swivel base;
wherein:
the transducer is mounted on a free end of the extension arm in a manner such that pivotal motion of the swivel base is converted into oscillating motion of the transducer along the arcuate path.

15. The linear motor assembly of claim 14 further comprising a connecting rod extending outwardly from the linear motor assembly and interconnecting the linear motor assembly to the swivel base.

16. The linear motor assembly of claim 14 further comprising a carriage slidably connected to the free end of the extension arm and being movable along the arcuate path, the transducer being mounted to the carriage.

17. The linear motor assembly of claim 16 wherein the transducer is configured to be removably connectable to the carriage.

18. The linear motor assembly of claim 16 wherein:
the arcuate path is defined by a spaced pair of arcuate tracks disposed in the housing;
the carriage having opposing sides and including a pair of rollers mounted on each of the opposing sides;
the rollers being sized and configured to move within the arcuate tracks.

19. The linear motor assembly of claim 13 wherein:
the housing comprises a handle portion and a detachable head portion having the pair of arcuate tracks disposed therein;
the head portion includes a track assembly mounted thereon and having a spaced pair of arcuately shaped track beams interconnected by a pair of struts;
each of the track beams having one of the arcuate tracks formed therewithin.

20. The linear motor assembly of claim 19 wherein the track assembly is configured to be removably attachable to the head portion.
